(19) United States
(12) Patent Application Publication
(10) Pub. No.: US 2005/0121309 A1
(43) Pub. Date: Jun. 9, 2005

(54) Method of producing nanoparticles

(76) Inventors: Manish Chhowalla, Cambridge (GB); Gehan Anil Joseph Amaratunga, Cambridge (GB); Noriaki Sano, Hyogo (JP); Haolan Wang, Cambridge (GB)

Correspondence Address: PILLSBURY WINTHROP SHAW PITTMAN, LLP, P.O. BOX 10500, MCLEAN, VA, 22102, US

(21) Appl. No.: 10/489,414

(22) PCT Filed: Sep. 11, 2002
(86) PCT No.: PCT/GB02/04133

(30) Foreign Application Priority Data
Sep. 14, 2001 (GB) 01223007

(51) Int. Cl. B01J 19/08

(52) U.S. Cl. 204/173

(57) ABSTRACT

A method of providing nanoparticles, especially carbon nanoonions, comprises generating an arc discharge between an anode and a cathode, both being submerged in a liquid and collecting the nanoparticles from the surface of the liquid, which may be an aqueous liquid, liquid ammonia, liquid helium, ethanol, methanol. Acetone, toluene, or chloroform.

The present invention relates to a method of producing nanoparticles, in particular but not exclusively to a method of producing nano-onions and nanotubes.

Carbon nanoparticles have received a great deal of attention since the discovery of the C₆₀ buckminsterfullerene molecule (H. W. Kroto, J. R. Heath, S. C. O'Brien, R. F. Curl and R. E. Smally, Nature 318, 162 (1985)) and the carbon nanotube (S. Iijima, Nature 354, 56 (1991)). Carbon nanoparticles are typically 1 to 100 nm in dimension, carbon nanotubes however being up to a few micrometres in length. The explosion in C₆₀ research in the early 1990s was driven by the production of large quantities (few milligrams) of the material by Krastchmer et al. (W. Kratschmer, L. D. Lamb, K. Fostiropoulos and D. R. Huffman, Nature 347, 354 (1990)) using a high pressure arc discharge method. A similar trend has occurred in carbon nanotube research. Carbon nanotubes are being considered for wide-ranging electronic and mechanical applications because of their extraordinary properties. However, for applications such as fuel cell electrodes and nano-composite materials, kilogram quantities of the material are desired. Presently, several industrial and governmental projects are underway to mass produce several kilograms of single and multi-walled carbon nanotubes in a cost-effective manner. For example, the National Institute of Materials and Chemical Research (NIMCR) and Showa Denko K. K. in Japan recently announced a project to develop a mass-production method to produce several hundred kilograms of nanotubes per day.

In addition to carbon nanotubes, a number of workers have reported the production of spherical or near-spherical carbon particles in the nanometre size range (1-100 nm in size) which are referred to as “nano-onions”. Such particles are interesting because they are expected to have superior lubrication properties. Carbon nano-onions generally consist of nested spherical, near-spherical, part-spherical and/or part-near-spherical shells, each shell being constituted by carbon atoms. Carbon nano-onions typically contain a central C₆₀ molecule. Generally nano-onions are between 1 and 100 nm in diameter. Initially, it was speculated that C₆₀ might be an effective solid state lubricant in both dry and wet environments. However, due to the small diameter of C₆₀, asperity to asperity contact between counter surfaces can take place, resulting in wear and friction. It is expected that nano-onions are large enough to prevent asperity to asperity contact. Furthermore, the closed cage structures have the distinct advantage of being chemically inert, due to the absence of dangling bonds, and elastic, making them ideal candidates as lubricants in reactive environments.

At present, however, nano-onions can only be produced in minute quantities by electron beam irradiation of amorphous carbon using a transmission electron microscope at 700° C. (D. Ugarte, Nature (London) 359, 707 (1993); F. Banhart, T. Fuller, Ph. Redlich and P. M. Ajayan, Chem. Phys. Lett., 269, 349 (1997)), annealing nano-diamonds at 1100-1500° C. (V. L. Kuznetsev, A. L. Chuvilin, Y. V. Butenko, I. Y. Mal'kov and V. M. Tikov, Chem. Phys. Lett. 222, 343 (1994)) and shock wave treatment of carbon soot (K. Yamada, H. Unishige and A. B. Sowaoka, Naturwissenschaften 78, 450 (1991)).

The inability to produce large quantities of spherical carbon nano-onions has led to the fabrication of inorganic fullerene molecules of MOS₂ and WS₂ (Y. Feldman, E. Wasserman, J. D. Srolovitz and R. Tenne, High-rate, Science 267, 222 (1994); R. Tenne, M. Homyonfer and Y. Feldman, Chem. of Materials 10, 3225 (1998)). These inorganic fullerene nanoparticles have shown excellent wear properties when dispersed into oil. In addition, fullerene-like MoS₂ thin films have shown very little wear and coefficient of friction (M. Chhowalla and G. A. J. Amaratung, Nature (London) 407, 164 (2000)). Therefore, the large-scale and cost effective production of spherical carbon nano-onions is of interest for many technological applications.

The widely used methods of production of carbon nano-materials require vacuum systems to generate plasma using an arc discharge (W. Kratschmer, L. D. Lamb, K. Fostiropoulos and D. R. Huffman, Nature 347, 354 (1990); S. Iijima and T. Ichihashi, Nature 363, 603 (1993)), laser ablation (A. Thess, R. Lee, P. Nikolaev, H. J. Dai, P. Petit, J. Robert, C. H. Xu, Y. H. Lee, S. G. Kim, A. G. Rinzler, D. T. Colbert, C. E. Scuseria, D. Tomanek, J. E. Fischer and R. E. Smalley, Science 273, 483 (1996)) or glow discharge (A. M. Cassell, J. A. Raymakers, J. Kong and H. J. Dai, J. Phys. Chem. B 103, 6484 (1999)). These methods have the disadvantages of high investment and running costs of the vacuum equipment and low yield of the desired products. Furthermore, in addition to the desired nano-materials, the vacuum processes also yield unwanted contaminants such as amorphous carbon and disordered nanoparticles so that a time consuming and costly purification step must be carried out. Therefore, a process allowing the generation of nanotubes or nano-onions with minimum contamination is necessary for their widespread use.

U.S. Pat. No. 5,753,088 (01k et al.) discloses a high yield method for multi-walled carbon nanotube synthesis that does not require a vacuum system. In this method, an arc discharge is generated in liquid nitrogen (or liquid helium or hydrogen) between two carbon electrodes. Recently, Ishigami et al. (M. Ishigami, J. Cumings, A. Zettl and S. Chen, Chem. Phys. Lett., 319, 457 (2000)) made a similar disclosure. Though this method is simpler than conventional methods, the product of this method, which is produced on the cathode and as deposit at the bottom of the liquid nitrogen vessel, is a complex mixture of carbon nanotubes and other carbon nanoparticles. The production of nano-onions is not reported. It would be advantageous to develop a method of obtaining desired nanoparticles separated from other products. Also, the rapid evaporation of the liquid nitrogen may pose a problem, and the use of liquid nitrogen is also inconvenient and expensive.

Surprisingly, it has now been discovered that an arc discharge in liquid between two electrodes can result in the formation of nanoparticles, especially nano-onions and nanotubes in high yield, certain of the nanoparticles, particularly the nano-onions, being separated from other products.

Accordingly, the present invention relates to a method of producing nanoparticles, the method comprising: generating an arc discharge between an anode and a cathode, the anode and the cathode both being submerged in a liquid; and collecting nanoparticles from the surface of the liquid.

The liquid is preferably an aqueous liquid, but may also be a non-aqueous liquid such as liquid ammonia, liquid helium, ethanol, methanol, acetone, toluene, chloroform or a mixture of two or more of these liquids.

The aqueous liquid is preferably water, more preferably distilled water, deionised water or filtered water (obtained by filtration of water through activated charcoal). However, the aqueous liquid may contain dissolved salt, for example dissolved sodium chloride and/or potassium chloride.

The nanoparticles are preferably nano-onions or nanotubes, but may also be other nanoparticles.

The nanoparticles are preferably carbon nanoparticles, but may also be particles of other materials.

The process may be operated at atmospheric pressure but may also be operated either at super or sub-atmospheric pressure, e.g. from 0.25 to 5 atmospheres, more preferably from 0.5 to 2 atmospheres. The pressure will affect the temperature at which the liquid boils and the rate of bubble production and/or the bubble size, which may in turn affect the flotation of the nano materials produced.

The cathode is preferably a carbon cathode and the anode is preferably a carbon anode. However, the cathode and anode may comprise other materials with hexagonal or wurtzite structures that readily form nanoparticles, such as MoS₂, WS₂, NbS, ZnS, CdS, BN, AlN, GaN, MgB₂, TiB₂ and TiSiₓ. Other suitable materials are described in “Crystal Structures”, Ralph W. G. Wyckoff, Second Edition, Volume 1, Interscience Publishers, John Wiley & Sons, 1963. Powders of these materials or powders of individual elements preferably mixed in the approximate stoichiometric ratios of these materials may be encapsulated within a carbon anode and/or cathode to produce nanoparticles of these materials or composite nanoparticles consisting of these materials and carbon.

The cathode may be composed of one material and the anode of another material in order to fabricate nanoparticles comprising both materials (for example, anode could be B and cathode Mg for fabricating MgB₂ nanoparticles).

Catalyst elements such as Ni, Co, Fe, Pt, Pd, Y, Au, Ga, Al, or alloys composed of these elements may be incorporated into one or more of the cathode and anode to improve the yield of nanoparticles.

The cathode and anode are preferably of different shapes for generating nano-onions but of similar shapes for generating nanotubes.

The arc discharge current is preferably at least 30 A.

The liquid is preferably cooled and/or circulated during the arc discharge.

The cathode and/or anode may be continuously replaced during the arc discharge. In particular, the cathode and/or anode may be continuously replaced by automatic feeding.

The method of the invention may further comprises a step of drying the collected nanoparticles. This step may be carried out in an oven.

The invention will be further described and illustrated with reference to a preferred embodiment as shown in the accompanying drawings, in which:

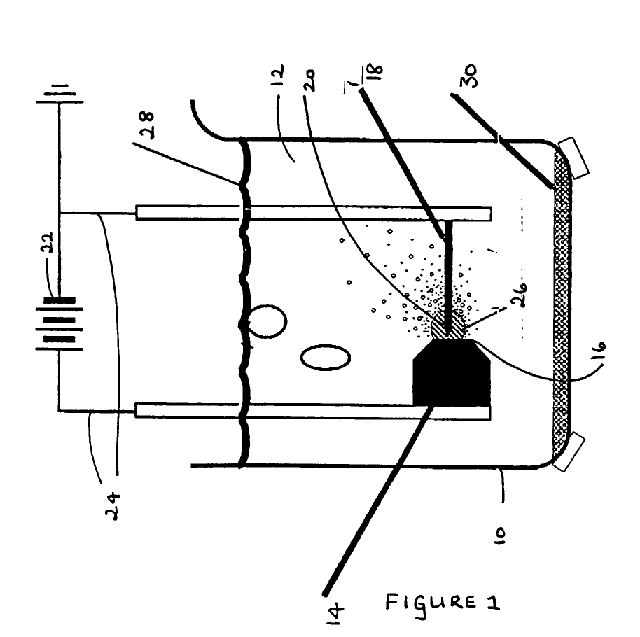

FIG. 1 shows a cross section of the apparatus used in a preferred embodiment of the invention.

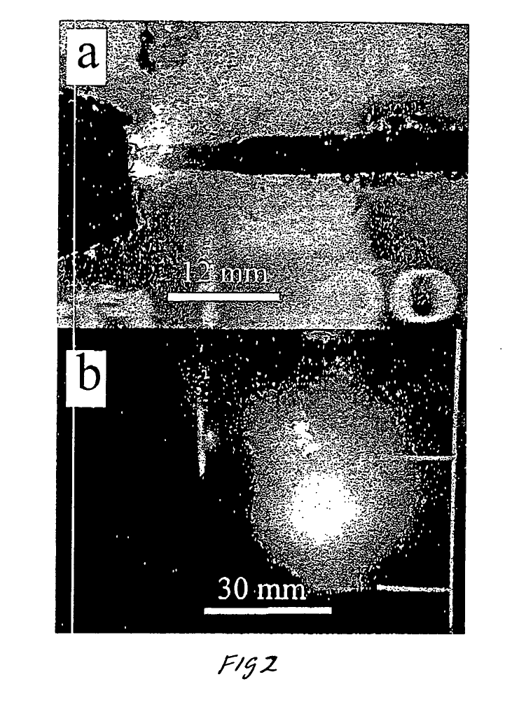

FIG. 2 shows digital images of the arc discharge in water which takes place in the preferred embodiment of the invention a) without a dark filter in front of the lens and b) with a dark filter in front of the lens.

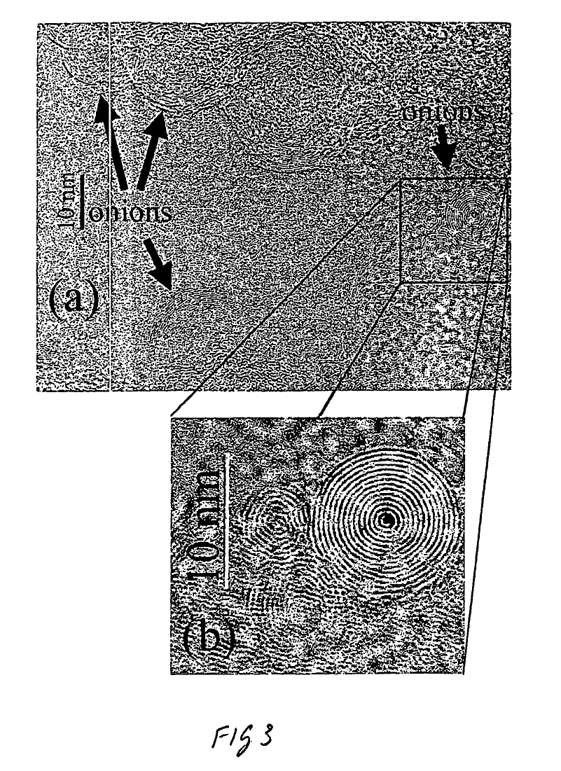

FIG. 3 shows high resolution transmission electron microscope (HRTEM) images of carbon nano-onions produced by the method of the preferred embodiment of the invention. FIG. 3a) shows spherical carbon nano-onions and larger polyhedral nested nanoparticles at low magnification. FIG. 3b) shows 7-, 10- and 15-walled carbon nano-onions at high magnification.

The apparatus used in the preferred embodiment of the invention (FIG. 1) comprises a pyrex beaker 10 which is partially filled with 2500 ml deionised water 12 (having resistance of 1.4 MΩ). A 99.9% pure graphite cathode 14 having a flat surface 16 of diameter 12 mm and a conical 99.9% pure graphite anode 18 having a tip 20 of diameter 5 mm are positioned inside the beaker 10 such that they are submerged in the distilled water 12, with the tip 20 of the anode 18 separated from the flat surface 16 of the cathode 14 by approximately 1 mm. The cathode 14 and anode 18 are connected across a battery 22 by electric wires 24 which are positioned outside the beaker 10. The anode 18 is grounded. In an alternative embodiment, the battery is replaced by an alternative direct current electricity supply, for example by a rectified mains electricity supply.

To carry out the method of the preferred embodiment of the invention, an arc discharge was initiated by contacting the tip 20 of the anode 18 with the flat surface 16 of the cathode 14 to produce a plasma ball 26. The anode 18 and the cathode 14 were then returned to their initial positions, separated by approximately 1 mm. The arc discharge voltage was 16-17 V and the arc discharge current is 30 A. The arc discharge was stable and could be run for several tens of minutes. The anode 18 was consumed during the arc discharge, meaning that the arc discharge was an anodic arc.

The plasma ball 26 of the arc discharge between the anode 18 and the cathode 14 can be seen in FIGS. 2a) and 2b) as a bright region. The plasma ball 26 can also be seen to surround the anode 18 in FIGS. 2a) and 2b), indicating the direction of the plasma expansion. In addition, fine black powder emitted from the plasma ball 26 region could also readily be observed visually. The diameter of the plasma ball 26 was measured from FIG. 2b) as approximately 15 mm.

After several seconds of arc discharge, a thin semi-transparent film of carbon nano-onions 28 on the water surface was readily visible. Carbon fragments 30 were also visible in the water in an approximately equal amount. When the water was allowed to settle for several minutes after the arc discharge, carbon could be observed visually at the base of the beaker and at the surface only, indicating that self-separation amongst the different emitted products had taken place. The material collected from the water surface was weighed without purification and the production rate was found to be approximately 30 mg/minute.

The unpurified material from the water surface was sprinkled onto holey carbon transmission electron microscopy (TEM) grids for investigation. The samples were left to dry at room temperature for 24 hours. The high resolution electron microscopy (HREM) was performed on a JEOL 4000EX microscope operated at 400 kV. A typical HREM image of the material is shown in FIG. 3a). Several spherical carbon nano-onions and polyhedral nested onion-like particles are readily seen and are indicated by arrows. A higher magnification image of spherical carbon nano-onions from FIG. 3a) is shown in FIG. 3b). In this region, spherical nano-onions with 7, 10 and 15 walls can be observed. The core of the larger nano-onion in FIG. 3b) was found to have a diameter of 7-8 Å, consistent with that of the C₆₀ molecule.

In order to confirm that the features observed in HREM were in fact spherical nanoparticles and not nanotubes with axes parallel to the electron beam, through focal series images were taken. Images taken through a series of focal lengths can resolve features above and below the focus plane of the object being observed. By performing this exercise for the image of FIG. 3b), it was confirmed that the structures observed are indeed spherical nanoparticles and that the core is comprised of the fullerene C₆₀.

The average diameter of the nano-onions extracted from the HREM study was 25-30 nm. However, a wide range of sizes were found, from 5 nm (FIG. 3b)) to a large nested onion with 45 layers and an outer diameter of 40 nm (FIG. 3a)).

The illustrated embodiment of the present invention provides a method of obtaining carbon nano-onions in high yield which are separated from other carbon nanoparticles without the need for a complex separation step, since the pure nano-onions are found as a film at the top of the water and other carbon nanoparticles are found at the bottom of the beaker. This result is particularly surprising. It was not previously known that carbon nano-onions could be generated by a method of this type, and neither was it previously known that carbon nano-onions could be obtained separately from carbon nanoparticles without the need for a complex separation step. The separation may be due to the density of water or other selected liquid being intermediate between that of the carbon nano-onions and other nanoparticles, or may be due to more complex factors such as interparticle interactions.

When the experiment was carried out with the preferred embodiment in water with electrodes having similar shapes, carbon nanotubes as well as carbon nano-onions were formed.

When an experiment was carried out using the apparatus of the preferred embodiment of the present invention except that deionised water was replaced with unpurified tap water, the efficiency of the process was reduced, and a larger proportion of carbon fragments at the bottom of the beaker was seen. Therefore, it is preferred that the method is carried out using distilled, deionised or filtered water, although satisfactory results may be obtained with unpurified water or water containing dissolved salts or other material.

As in a conventional fullerene reactor, the plasma ball 26 is generated by thermal evaporation of the anode 18. Therefore, unlike cathodic arc plasmas, the carbon vapour is generated by thermionic rather than thermo-field emission. In the case of thermionic emission, the majority of the emitted carbon species are not expected to have high directional velocities. The formation of carbon clusters such as C₆₀ and carbon nano-onions in a fullerene reactor is governed by the homogenisation of the emitted carbon vapour. In contrast, the presence of an axis of symmetry in a fullerene reactor leads to elongated structures such as carbon nanotubes (E. G. Gamaly and T. W. Ebbesen, Phys. Rev. B 52, 2083 (1995)). In the preferred embodiment of the invention, an axis of symmetry is absent due to the different shapes of the anode 18 and cathode 14. However, in alternative embodiments an axis of symmetry may be present to promote the generation of carbon nanotubes in preference to carbon nano-onions.

The evaporation rate of the water during the arc discharge is estimated to be 3 ml/minute. This is significantly less than would occur using liquid nitrogen at ambient temperature. Evaporation might be reduced by chilling the water or by circulation of the water.

The carbon nano-onions produced by the method of the preferred embodiment of the invention may be suitable for many lubrication applications, for example wet lubrication, as discussed above, because of their size. IF-WS, particles of similar size and shape have been found to be more effective as solid state lubricants when dispersed in oil than the conventionally used 2H MoS₂ crystals (L. Rapoport, Yu. Bilik, Y. Feldman, M. Homyonfer, S. R. Cohen and R. Tenne, Nature (London) 387, 791 (1997)). The carbon nano-onions may also have other applications, for example in structural nano-composite materials or in fuel cell electrodes.

The method of the preferred embodiment of the present invention has the advantages over previous methods of carbon nano-onion and nanotube synthesis in that it is suitable for large-scale production and it is likely to be more economical. In particular, a high yield of carbon nano-onions is obtained, no vacuum apparatus is necessary, and no complex separation steps are involved.

Whilst the invention has been described with reference to the illustrated embodiment, it will be appreciated that various modifications are possible within the scope of the invention.

1-25. (canceled)

26. A method of producing nanoparticles, which method comprises:
generating an arc discharge between an anode and a cathode, the anode and the cathode both being submerged in a liquid; and collecting nanoparticles from the surface of the liquid.

27. A method as claimed in claim 26, wherein the liquid is an aqueous liquid, liquid ammonia, liquid helium, ethanol, methanol, acetone, toluene, chloroform or a mixture of two or more of these liquids.

28. A method as claimed in claim 27, wherein the liquid is an aqueous liquid and the aqueous liquid is distilled water, deionised water, or filtered water.

29. A method as claimed in claim 27, wherein the liquid is an aqueous liquid and the aqueous liquid contains dissolved salt.

30. A method as claimed in claim 29, wherein the dissolved salt is one or more of sodium chloride and potassium chloride.

31. A method as claimed in claim 26, wherein the nanoparticles collected from the surface are nano-onions.

32. A method as claimed in claim 31, wherein nanoparticles are also collected from the bottom of the liquid.

33. A method as claimed in claim 32, wherein the nanoparticles collected from the bottom of the liquid are nanotubes.

34. A method as claimed in claim 26, wherein the nanoparticles are nanotubes.

35. A method as claimed in claim 26, wherein the nanoparticles are carbon nanoparticles.

36. A method claimed in claim 26, wherein one or more of the cathode and anode comprises carbon.

37. A method as claimed in claim 26, wherein one or more of the cathode and anode comprises a material selected from MoS₂, WS₂, NbS, ZnS, CdS, BN, AlN, GaN, MgB₂, TiB₂ and TiSiₓ.

38. A method as claimed in claim 37, wherein the powdered material is embedded in one or more of the cathode and anode.

39. A method as claimed in claim 26, wherein powdered elements in the approximate stoichiometric ratio of a material selected from MoS₂, WS₂, NbS, ZnS, CdS, BN, AlN, GaN, MgB₂, TiB₂ and TiSiₓ are embedded in one or more of the cathode and anode.

40. A method as claimed in claim 26, wherein one or more of the cathode and anode comprises a catalyst material selected from Ni, Co, Fe, Pt, Pd, Y, Au, Ga, Al, and alloys composed of these elements.

41. A method as claimed in claim 26, wherein the cathode and anode are of different shapes.

42. A method as claimed in claim 26, wherein the cathode and anode are of similar shapes.

43. A method as claimed in claim 26, wherein the arc discharge current is at least 30 A.

44. A method as claimed in claim 26, wherein the liquid is cooled during the arc discharge.

45. A method as claimed in claim 26, wherein the liquid is circulated during the arc discharge.

46. A method as claimed in claim 26, wherein one or more of the cathode and anode is continuously replaced during the arc discharge.

47. A method as claimed in claim 26, further comprising a step of drying the collected nanoparticles.

48. A method as claimed in claim 47, wherein the step of drying the collected nanoparticles is carried out in an oven.

49. A method as claimed in claim 26, wherein the arc is an anodic arc.

50. A method as claimed in claim 26, conducted at a pressure of from 0.5 to 2 atmospheres.
